(19) United States
(12) Patent Application Publication
(10) Pub. No.: US 2015/0081687 A1
(43) Pub. Date: Mar. 19, 2015

(54) System and method for user-generated similarity ratings

(71) Applicant: Raymond Lee, Los Angeles, CA (US)

(72) Inventor: Raymond Lee, Los Angeles, CA (US)

(21) Appl. No.: 14/553,987

(22) Filed: Nov. 25, 2014

(51) Int. Cl. G06F 17/30

(52) U.S. Cl. CPC G06F 17/30867
USPC 707/723; 707/749

(57) ABSTRACT

In this universal comparison project tentatively called “Claaang,” users rate the relationship, e.g. likeness, similarity, sameness, semblance, or resemblance, between two or more things. Ratings are determined subjectively by individual users. Claaang keeps comparisons as simple as possible by representing each one with a single number. Some existing websites allow users to make consumer comparisons, but do not allow users to rate the relationships between items. Additionally, some sites provide a user the ability to compare naturally similar things only. Claaang allows for any combination of objects to be given a rating, whether they are commonly or naturally similar or not. This may reveal insights about human perception. Claaang accepts user input or votes about similarity, uses votes to adjust overall similarity ratings, and displays current ratings when prompted. Claaang is best implemented from a single server on the internet, so that it is a worldwide project.

### 1. FIELD OF THE INVENTION

This invention is in the field of data processing, in particular data structures.

### 2. BACKGROUND OF THE INVENTION

Many websites or apps offer “recommendation” services. If a user enters the name of a particular movie, the website might recommend movies that have objective similarities, such as movies in the same genre or with the same actors. The information for each movie is stored in a database; the website performs a simple search for similar terms in the database.

Other websites offer “comparison” services. A consumer shopping for a car might go to a website that has information about many cars. He would find tables comparing multiple features (such as body type, price range, mileage, type of transmission, etc.) for many models.

The present invention describes a system where users can compare the similarity of any two records. I will call the system “Claaang” for the purposes of this description. Claaang is implemented as a website or an application for handheld electronics. A “record” for the purpose of this invention is any concept that can be described with a word or data file. The similarity between two records is assigned a point value by each individual user. Claaang maintains an average rating for each pair of records. This allows Claaang to determine which records are most similar to any given record in its database.

The purpose of Claaang is to allow human-generated, subjective matches between records. A user might hear a particular piece of music that he likes. He would be interested in finding what other pieces of music are very similar to it—not by objective measures such as songwriter or genre, but by subjective human judgment. To do so, he would go to Claaang and input the name of the song that he likes, “Song A.” Claaang would produce a list of songs that have been ranked highly similar by other users, songs B, C, and D etc. The user would also have an opportunity to provide his own subjective input. He could rank the similarities between Songs A and B according to his own subjective impression. His vote would affect Claaang's overall rating for future users.

### 3. DESCRIPTION OF RELATED TECHNOLOGY

There are several websites in the general field of recommendations or comparisons, none of which allow users the opportunity to provide a numerical similarity ranking between any two records.

SocialCompare.com offers user-generated tables to compare particular products in the high-tech industry. For example, the page for eReaders (as of October, 2014) lists several Amazon and Nook products, etc. It has a table with many features, such as screen size, price, library, and numerous technical specifications. Users may view recently compared items or select multiple items for comparison if they subscribe to the site. A comparison comes in the form of a table, listing several products across the top row and several relevant features down the left column. There are at least two main differences between SocialCompare.com and Claaang. First, SocialCompare only applies to products in the high-tech industry (software, tablets, printers, etc.) Second, SocialCompare.com uses a much more objective and complex system of comparisons. Claaang summarizes the similarity between items in one very simple measure—a number. The number is based on subjective human evaluation rather than objective measures.

Alternative.to is mostly intended for consumer choices, with a wider range of products than SocialCompare.com. The user can enter in something like “Lady Gaga.” The website will produce a number of “articles” about the term, and sometimes “alternatives” (such as “Rihanna,” “Kesha,” and “Britney Spears” in this case). Users can add their own suggested alternatives. Each alternative is ranked by a thumbs-up/thumbs-down system. That is, the match between Britney Spears and Lady Gaga is ranked 2 “Good” vs. 1 “Not Really.” There are at least two main differences between Alternative.to and Claaang. First, Alternative.to only provides or encourages comparisons between records that are very similar. Claaang allows for comparisons between any two records, even if they are different. “Pencil” could be compared to “dog.” Second, the Alternative.to rating system is based on a binary rating system of “Good” or “Not Really.” Claaang allows a much finer scale of numeric ratings, e.g. on a scale from 0 to 100. This allows for much more precise resolution of comparisons between highly similar records.

AlternativeTo.net is devoted strictly to recommending software alternatives. For example, clicking on Dropbox pulls up a long list of alternatives including Google Drive, Microsoft OneDrive, CloudApp, etc. Each product is rated simply by number of Likes. The Likes are for each product individually, not comparisons between products. There are at least two main differences between AlternativeTo.net and Claaang. First, the scope of material in AlternativeTo.net is limited to the very narrow range of consumer-oriented software. Second, AlternativeTo.net does not offer rankings between pairs of items at all.

Likewise, SitesLike.com is devoted to website recommendations. SitesLike.com provides a fixed list of websites in specific categories (comedy, cooking, education, music, etc.) Each category lists ten sites on the main page. When you click on one (such as “Pandora,”) it provides you with a list of dozens of “Sites Like” Pandora. Some of them, like Hulu, are on-point. Others, like NPR or Fox News, are not. No other information is offered about the sites or how they are determined to be “like” Pandora. There are significant differences between Claaang and SitesLike.com. SitesLike.com is focused on websites only. It does not offer user interaction, and does not rank or explain its recommendations.

SimilarSites.com is very similar to SitesLike.com. When the URL of a website is entered into its search bar, SimilarSites.com returns a list of sites that are similar. Each site is assigned a percentage similarity to the reference website. SimilarSites.com does not give any indication of how the percentage scores are determined, and there does not seem to be an interactive element to it.

Diffen.com deals with broader concepts than SitesLike.com or AlternativeTo.com. Typing in two related terms may produce a full article comparing their features. The site invites wiki-participation, and devotes articles to the most popularly requested comparisons. For example, the input “dog vs. cat” calls up a pre-written article toting the pros, cons, and differences between the two choices of pet. An input such as “dog vs. carrot” does not produce much except a picture of a dog and the indication that dogs are animals and carrots are plants. One main difference between Diffen.com and Claaang is that the input to Diffen.com is two records to be directly compared. The input to Claaang is just one record, and Claaang produces a list of the most similar matches. Furthermore, Diffen.com does not rate matches on a numerical scale.

DifferenceBetween.com is similar to Diffen.com. This site has a focus on business, but with a few categories to choose from such as Technology, Science, and Language. With an input such as “yellow,” the site will present a list of pre-written articles such as “Difference Between Yellow Pages and White Pages.” There is no numeric rating between pairs of records. Furthermore, DifferenceBetween.com is not interactive. The articles are pre-written by staff. As the company explains in its “About” page, “We team up with selected academics, subject matter experts and script writers across the world.”

There is also a DifferenceBetween.net, which is, like DifferenceBetween.com, attributed to the company Difference Between. DifferenceBetween.net does welcome some article contributions by users, but only on a selective, paid basis.

FindTheBest.com has multiple main categories such as Doctors, Lawyers, Employees, Homes, and Business Resources. Each main category has several sub-categories. For example, Motors includes cars, planes, motorcycles, etc. When a sub-category such as cars is selected, the user may enter several parameters such as body type, price, etc. The site then gives a ranked list of the individual cars, e.g. from best to worst. It does not directly compare one car to another.

Claaang is different from all the websites described above. Claaang can accept an input of one record, in which case it will return a list of the most similar matches. Alternatively, Claaang can accept as input a pair of records, in which case it will provide a numeric rating between them. Claaang's ratings come from users, not from professionals or website staff. Claaang's rating system is a numeric scale. This keeps the comparisons as simple as possible, so that the user does not get overwhelmed by lengthy articles or massive tables of specifications. The simplicity of Claaang's rating system allows its database to grow and change quickly. It also ensures that the similarities are based on human subjective feelings rather than objective details. For example, three songs may be in the same key and use the same instruments, yet one of them might sound very different from the other two. When a user says, “I like Song A. I wonder what other songs are similar so that I would like them too,” he is looking for a subjective human rating that a computerized table of specifications may not be able to provide. Claaang can provide him with the best matches.

Wayne Chase holds U.S. Pat. No. 6,523,001 (2003) for an “Interactive Connotative Thesaurus System.” Chase has also posted an inactive website, connotative.com. In his patent, Chase described a system for associating words with “connotative synonyms” and “areas of human interest.” “Connotative synonyms” are words that have similar emotional significance and not just dictionary definitions. The connotative meanings are provided by “select panels of evaluators.” Chase wrote, “scaled ratings of the power, activity and abstract/concrete qualities of the word or phrase are also maintained.” On the website, Chase explains the purpose of his proposed system: “Words such as celebration, springtime, and kiss arouse unique assemblages of positive emotional connotations. Words such as homeless, cancer, and rape summon clouds of negative emotional connotations. Many words and phrases, such as bullfight, call up mixed positive and negative connotations. Connotative meaning also includes the evocation of other sensations and impressions, such as power (e.g., war) and activity (e.g., carnival). Today's dictionaries and thesauruses are completely devoid of connotative meaning. However, as you will see at this Web site, new emotional language reference products will soon change the world of language reference. The full range of connotative or emotional meaning associated with all the words of an entire language will be available to everyone.”

It should be noted that Chase is describing an abstract linguistic concept. It would be useless to use Chase's thesaurus to compare brand names or songs, for example. Claaang will be useful for concrete decision-making and commercial products. Furthermore, Chase has not been able to implement his concept in practice. His website is still non-functional after two decades.

Unlike the other systems, Claaang allows ratings between records that may seem disparate on their face. The purpose for this is to allow discovery of nuanced similarities that computers might not recognize. For example, users may recognize some degree of subjective similarity between “cotton” and “clouds” even though they have many profound differences.

### 4. SUMMARY OF THE INVENTION

The main components of Claaang are a selection database, a user interface, a vote database, a rating adjustment process, and a ratings database. These terms are defined below in conjunction with other terms that are essential to the invention.

“Claaang” is the system and method described by this entire patent.

A “record” is any concept that can be described with words or data files.

The “selection database” is the database containing all records in the Claaang system.

An “administrator” is a person in charge of programming or administering the Claaang system.

A “user” is a person who is using Claaang to discover or rate similarities among records.

A “sponsor” is a person or corporation who submits some of its proprietary material to the selection database.

An “online source” is a tributary of information available on the internet that is not an administrator, user, or sponsor. Examples are online dictionaries, encyclopedias, and news sources.

A “computer” is any digital data-processing device with a processor, memory, input means, and output means.

A “server” is a computer in the control of the administrators.

The “internet” is the worldwide network of computers capable of exchanging data using standard protocols.

The “user interface” is the manifestation of the Claaang system on the user's computer, for example its appearance on the user's screen and its interaction with the user's inputs.

A “rating” is an overall degree of similarity between two records. In Claaang, a rating is a number.

A “vote” is one input into Claaang about what a rating should be. The vote may come from an administrator, user, sponsor, or computer.

The “rating adjustment process” is the procedure by which Claaang determines the overall rating for a pair of records in the selection database. The rating adjustment process will respond to user votes, administrator or sponsor input, and default calculations.

The “ratings database” is the symmetric matrix of ratings for every pair of records in the selection database. For example, if there are three records in the selection database, A, B, and C, then the rating database would take the following form, with three independent overall ratings. If there are n records in the selection database, then there will be approximately ½ n² independent ratings in the rating database.

| | A | B | C |
|---|---|---|---|
| A | 100 | — | 51 |
| B | — | 100 | 13 |
| C | 51 | 13 | 100 |

For any given record, a “match” is a different record for which a rating exists between the two records in the rating database. If a pair of records has received no votes, then the records are not matches for one another. If a pair of records has received at least one vote, even if it is a low vote, the records are matches for each other. In the example above, A and B are not mutual matches because the pair (A, B) has not yet received any votes and therefore has no well-defined rating.

To initialize the system, records are entered into the selection database by administrators and sponsors.

When a user has a record in mind, he may open the Claaang user interface and conduct a search for that record. The user interface will present the user with a list of that record's top matches according to the rating database.

When a user wishes to view the current rating between two records, he may enter both of them at the user interface. The user interface will then present the user with the current numeric rating for those two records.

The user interface allows each user to enter new records into the selection database.

The user interface also allows each user to cast a vote for a rating between any two records in the selection database. The rating adjustment process then adjusts the corresponding rating according to the new vote.

### 5. BRIEF DESCRIPTION OF THE DRAWINGS

FIG. 1 depicts the interactions among the participants and components of the system.

FIG. 2 depicts the user interface when an online source is assisting the user by providing recommendations similar to the user's search term.

FIG. 3 shows a typical view of the user interface after the user conducts a search for a record that is in the selection database, and that has matches in the rating database.

FIG. 4 shows a typical view of the user interface after the user casts a vote between two records.

FIG. 5 shows a typical view of the user interface after the user conducts a search for a record that is not yet in the selections database, or does not yet have matches in the rating database.

FIG. 6 shows a typical view of the user interface after the user creates a new entry in the rating database.

### 6. DETAILED DESCRIPTION OF THE PREFERRED EMBODIMENTS

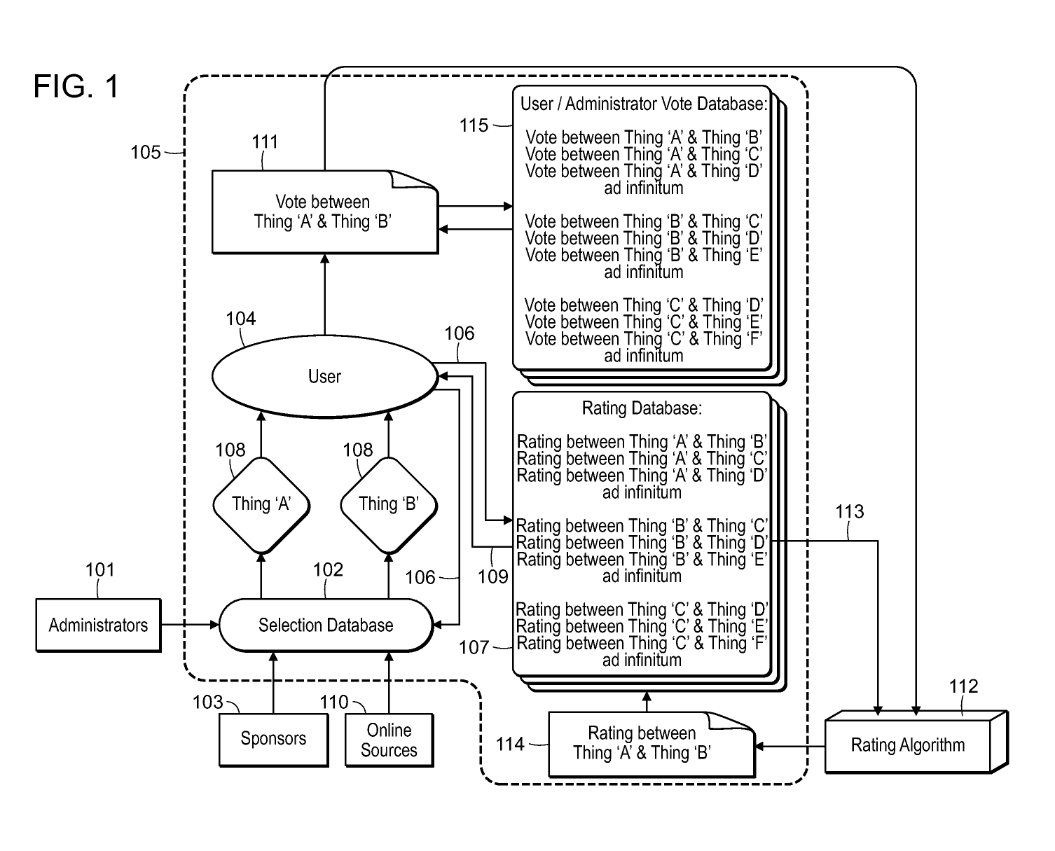

See FIG. 1 to follow the general flow of information through the system and method.

The Claaang system and method is created by administrators (101), who create the initial records in the selection database (102). Additional records may be added to the selection database by sponsors (103).

A user (104) logs onto the Claaang system via the user interface (105) on the user's computing device. The user sends queries (106) to the selection database and/or the rating database (107). The selection database returns one or more records (108) to the user. The rating database returns one or more ratings (109) to the user.

When the user submits a query (106), the selection database may provide recommendations of records (108) that fit the query. For example, if the user enters “yellow,” the selection database may indicate that it has records for “yellow submarine,” “yellow fever,” a sound file of the song “Yellow Submarine,” or an image of a banana with the keyword “yellow” in its description. Recommendations may also be provided by an online source (110) such as a search engine that is coordinated with the selection database. The user may select one of the recommended records to confirm his finalized search term.

After the user confirms which record is the subject of his finalized search term, the rating database provides the user with a list of that record's matches and their similarity ratings (109). The records that are provided might be the highest-rated matches, the matches with ratings above a minimum threshold, or a complete list of all matches ranked in order of rating.

If the user would like to cast a vote between two records, then he selects those two records from the selection database within the user interface. His vote (111) is then stored in a database of individual votes (115) and transmitted to the rating adjustment process (112), also labeled as the “rating algorithm” in FIG. 1. The rating adjustment process receives the user's vote as well as the previous overall rating (113) between the two records from the rating database. The rating adjustment process then updates the rating database with the new overall rating (114) between these two records. The new overall rating (114) is immediately displayed to the user.

The user may also create new records directly in the selection database.

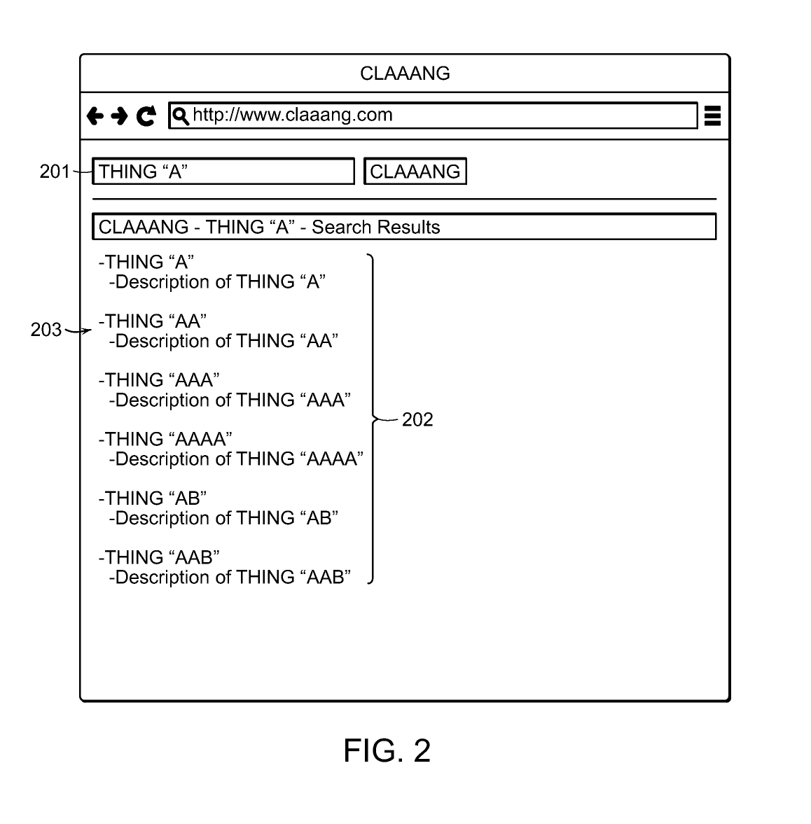

Refer to FIGS. 2-6 for displays of the user interface (105) at various stages of the procedures.

In FIG. 2, the user's preliminary search term (201) is “Thing A.” This term is submitted as a query (106) to the selection database. The selection database may assist the user by providing recommendations (202) preliminarily identified as similar to the user's search term. To assist with these recommendations, the selection database may be working in conjunction with online sources (110) such as search engines, online dictionaries or encyclopediae, repositories of images or videos, etc. In FIG. 2, the recommendations (202) presented to the user are “Thing A, Thing AA, Thing AAA, Thing AB, and Thing AAB.” The user selects his finalized search term (203) from among this list. In this example, we will suppose that user's finalized search term is “Thing AA.” This finalized search term (203) is sent out as a query (106) to the rating database.

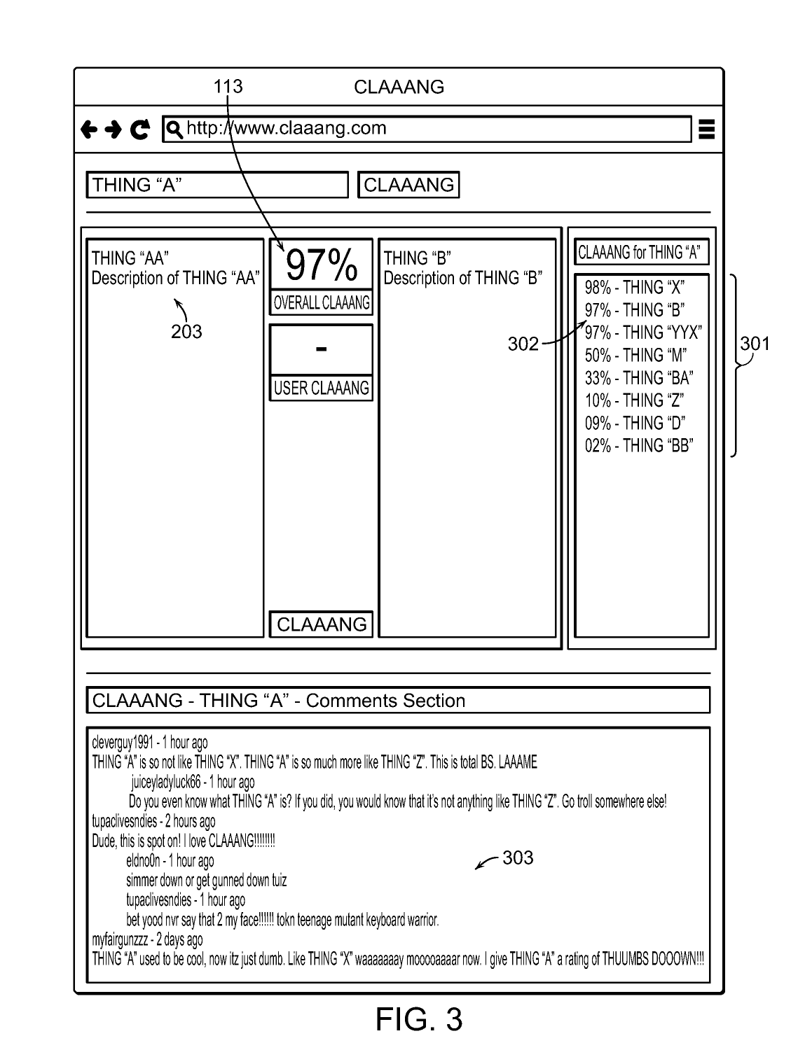

The user interface then appears as FIG. 3. The user's finalized search term (203), “Thing AA,” is shown in a first portion of the display, along with a description. In a second portion of the display, Claaang presents a list of matches (301) from the rating database (107). Depending on settings, the rating database might return all matches, that is, all records that have a well-defined rating with the finalized search term (203). Alternatively, the matches (301) that are displayed might be only those above a certain minimum threshold, or they may be a preset number of top matches, such as the Top 10.

From the list of matches (301), the user chooses one selected match (302). In the example of FIG. 3, the user has chosen the selected match “Thing B.” The display shows that the previous rating (113) between “Thing AA” and “Thing B” is 97%.

FIG. 3 also shows an auxiliary section (303) where users may leave comments, communicate with each other, link Claaang to social network profiles, etc.

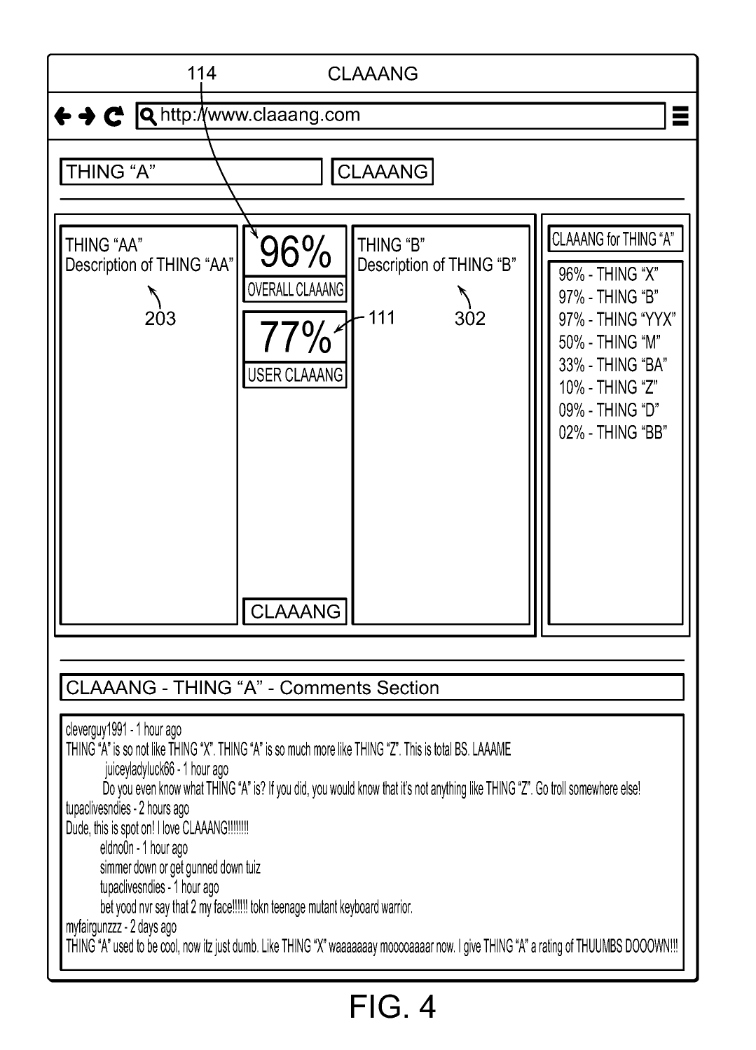

FIG. 4 shows the next step after FIG. 3. The user enters his own vote (111) for the similarity rating between his finalized search term (203) and his selected match (302). In this example, the user's vote (111) is 77%. This vote is used to update the similarity rating for this pair of matches. The previous rating (113) of 97% has been downgraded to the new rating (114) of 96%.

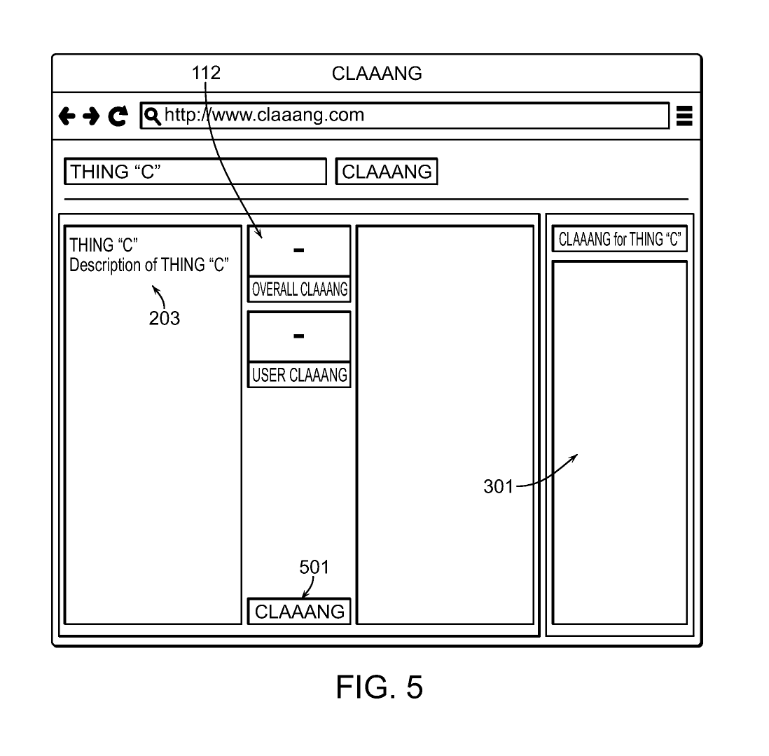

In FIG. 5, the user has submitted a finalized search term (203), in this example “Thing C,” that has no matches (301) in the rating database. The fields displaying the matches (301) and the previous rating (113) are empty. In this case, the user can select an add option (501) to add a new match. The add option can even be used in the presence of previous matches (301) though such an example is not illustrated here.

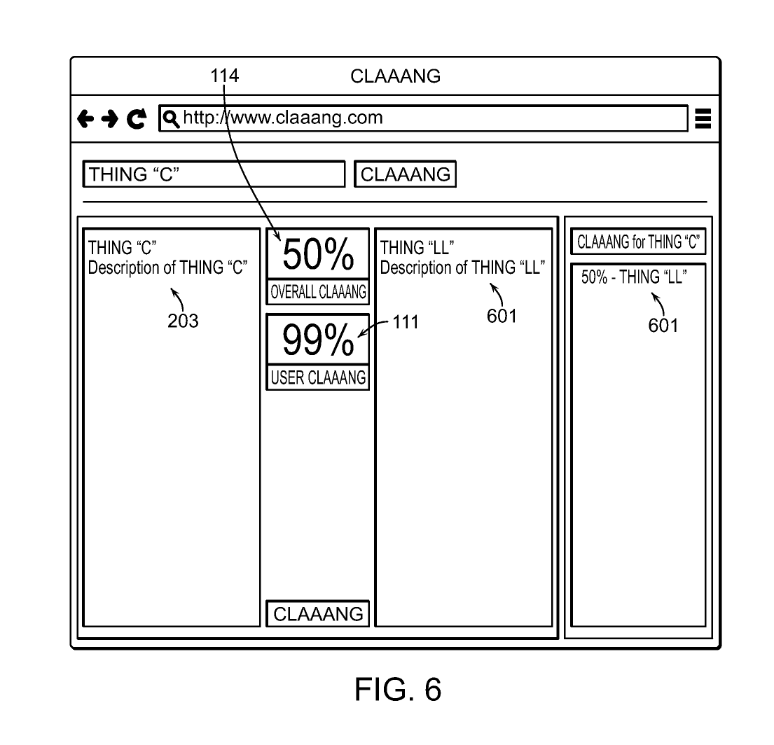

After selecting the add option (501), the user adds a new match (601) as shown in FIG. 6, where it is exhibited as “Thing LL.” The user then casts his vote (111) for the pair consisting of his finalized search term (203) and his new match (601). The vote (111) is passed on to the rating adjustment process (112), which then returns a new rating (114). Note that the new rating is not necessarily equal to the first vote (111) cast. The rating adjustment process may be as simple as a cumulative vote average, in which case the new rating (114) would be identical to the first vote (111). Alternatively, the rating adjustment process could use a Bayesian average, which incorporates default information when there are a small number of ratings. In the example shown in FIG. 6, the rating adjustment process computed the mean of the vote (111) and a default vote of 1%, to obtain an average new rating (114) of 50%.

I claim:

1. A process, on a computer-based network, for transforming a database of records into a useful, concrete, and tangible database of similarity ratings among the records, comprising the steps of:
creating a selection database, vote database, and ratings database in the memory of a server on the network;
programming the server with a rating adjustment process;
receiving at least two records into the selection database, each record comprising words or other digital information pertaining to a particular concept;
receiving a vote, into the vote database, for a degree of similarity between two records in the selection database;
transferring the vote between the two records from the vote database to the rating adjustment process;
transferring the previous rating between the two records from the ratings database to the rating adjustment process;
transforming the previous rating between the two records into a new rating between the two records, by the rating adjustment process and as determined by the vote;
transferring the new rating from the rating adjustment process to the ratings database.

2. The process of claim 1, wherein
the source of each record received into the selection database is chosen from the set of administrators, users, sponsors, and online sources;
the source of each vote received into the vote database is chosen from the set of administrators, users, sponsors, and online sources.

3. The process of claim 1, wherein
each vote and rating is a number;
the rating adjustment process calculates a weighted mean between the vote and the previous rating;
in the event that there is no previous rating, the new rating is identical to the vote.

4. The process of claim 1, wherein
each vote and rating is a number;
the rating adjustment process calculates a weighted mean between the vote and the previous rating;
in the event that there is no previous rating, the new rating is a Bayesian mean determined by the vote and at least one default value provided by administrators.

5. The process of claim 1, further comprising steps for displaying similarity ratings among the records, including:
receiving a query for a rating of similarity between two records in the selection database;
retrieving, from the ratings database, the rating of similarity between the two records;
displaying, on the querying computer, the rating between the two records.

6. The process of claim 5, wherein the source of the query is chosen from the set of administrators, users, sponsors, and online sources.

7. The process of claim 1, further comprising steps for displaying a list of records most similar to a first record, including:
receiving a query about a first record in the selection database;
retrieving, from the ratings database, the records with the highest degree of similarity to the first record;
displaying, on the querying computer, the retrieved records along with their similarity ratings to the first record.

8. The process of claim 7, wherein the source of the query is chosen from the set of administrators, users, sponsors, and online sources.

9. A system of computers on the internet programmed to transform a database of records into a database of similarity ratings among the records, comprising the components of:
a server under the control of administrators;
a selection database, in the memory of the server, for receiving and storing records, each record comprising words or other digital information pertaining to a particular concept;
a vote database, in the memory of the server, for receiving and storing votes for a degree of similarity between pairs of records in the selection database;
a ratings database, in the memory of the server, for receiving and storing ratings between pairs of records in the selection database;
a processor of the server, programmed to transform a vote and a previous rating between a pair of records in the selection database into a new rating between the pair of records;
at least one computer under the control of at least one user, for exchanging records, votes, and ratings with the server.

10. The system of claim 9, further comprising at least one computer under the control of at least one sponsor, for exchanging records, votes, and ratings with the server.

11. The system of claim 10, further comprising at least computer under the control of a third party known as an online source, for providing records and information about records to the server.

12. The system of claim 9, wherein
each vote and rating is a number;
the new rating between the pair of records is a weighted mean between the vote and the previous rating;
in the event that there is no previous rating, the new rating is identical to the vote.

13. The system of claim 9, wherein
each vote and rating is a number;
the new rating between the pair of records is a weighted mean between the vote and the previous rating;
in the event that there is no previous rating, the new rating is a Bayesian mean determined by the vote and at least one default value determined by administrators.

14. The system of claim 9, further comprising means to display similarity ratings among the records, including at least one computer under the control of at least one user, for submitting a query to the server about the similarity rating between two records in the selection database, receiving the similarity rating queried, and displaying the similarity rating.

15. The system of claim 9, further comprising means for displaying records most similar to a first record, including at least one computer under the control of at least one user, for submitting a query to the server about a first record in the selection database, receiving the additional records most similar to the first record, and displaying the additional records and the similarity ratings between the first record and each additional record.
